(19) United States
(12) Patent Application Publication
(10) Pub. No.: US 2026/0030695 A1
(43) Pub. Date: Jan. 29, 2026

(54) MULTIFACETED REAL ESTATE PLATFORM AND METHOD OF USING THE SAME

(71) Applicant: Hamza Hakimi, Madrid (ES)

(72) Inventor: Hamza Hakimi, Madrid (ES)

(21) Appl. No.: 18/780,736

(22) Filed: Jul. 23, 2024

(51) Int. Cl. G06Q 50/16; G06T 7/73; G06T 11/00

(52) U.S. Cl. CPC G06Q 50/16; G06T 7/74; G06T 11/00; G06T 2207/10016

(57) ABSTRACT

A multifaceted real estate platform provides services to two primary user types: sellers/buyers and real estate agencies. The platform facilitates the listing process as well as viewing and interacting with real estate properties through augmented reality and conventional methods.

### BACKGROUND OF THE INVENTION

Traditional real estate marketing relies mostly on printed media such as magazines, brochures, and newspaper, as well as visual/audio means such as TV and radio advertising. While still being used now a days, their reach and effectiveness have diminished with the decline of print readership.

“For Sale” signs and “Open House” showings are also used to market properties. In the case of “For Sale” signs, while being a cost-effective way to announce a property availability, it lacks the detailed information and visual appeal desired by prospect buyers. On the other hand, “Open House” showings offer a chance for buyers to experience the property firsthand. However, it can be a time-consuming activity for both sellers and agents, and the number of attendees can be unpredictable which can be a deterrent for some buyers.

To address these constraints, the real estate market has complemented traditional marketing strategies with digital marketing strategies relaying in the widespread availability of the Internet, websites and social media.

Up until now, when searching for real estate, there were property websites with descriptions of properties, neighborhoods, and surroundings. However, the person conducting the searches couldn't have any idea about the exact location of the property, how it appeared, the neighborhood, surrounding businesses, schools, noise disturbances, among other considerations.

These factors lead to multiple visits before finding a property that suits the person searching, as well as the professionals marketing these properties averaging 11.4 visits for property sales and 5.2 stops for rentals.

Thus, what is needed is a digital solution for all the individuals and entities involved in the real estate environment that facilitates the listing, viewing, and interaction with real estate properties through both conventional and augmented reality methods.

### SUMMARY OF THE INVENTION

The invention is a multifaceted real estate platform providing services to two primary user types: sellers/buyers and real estate agencies. The invention facilitates the listing process as well as viewing and interacting with real estate properties through innovative and convention methods.

According to an aspect of the invention, the multifaceted real estate platform is a FLUTTER-based mobile application for standard user interface interactions and data management. Real estate property data submitted by users is sent to a NODE.JS-based API, which validates the information and stores it in a POSTGRESQL database. This conventional pathway ensures robust data handling and validation, with comprehensive error reporting to enhance user experience and data integrity.

According to another aspect of the invention, the multifaceted real estate platform is integrated with Unity for augmented reality functionalities, providing an immersive property exploration experience. This aspect utilizes Google's ARCORE technology, including the ARCORE Geospatial API, to allow users to explore real estate listings in augmented reality.

According to yet another aspect of the invention, the multifaceted real estate platform provides a method that associates real-time geospatial data to anchor digital content, such as 3D models of properties, in the physical world, based on user location and orientation.

According to one aspect of the invention, the multifaceted real estate platform employs advanced algorithms to ensure the precision of property placement in the AR environment, using thresholds on horizontal accuracy and interpolations from the EGM96 earth gravity model to compute exact geographical locations.

According to another aspect of the invention, the multifaceted real estate platform provides a dual approach by combining traditional listings with AR-enhanced viewing providing both high functionality and an engaging user experience. The use of augmented reality to enhance real-world interactions represents a significant leap in how users interact with real estate platforms, transforming the industry's standard practices.

### BRIEF DESCRIPTION OF DRAWINGS

To provide a more complete understanding of the present invention and the features and advantages thereof, reference is made to the following description taken in conjunction with the accompanying drawings, in which:

FIG. 1 shows a general block diagram of multifaceted real estate platform, according to the present invention.

FIG. 2 shows a general block diagram of a client device, according to the present invention.

FIG. 3 shows a general block diagram of a server, according to the present invention.

FIG. 4 shows a block diagram of the system modules, according to the present invention.

FIG. 5 shows a block diagram of the AR-Based Property Exploration module, according to the present invention.

FIG. 6 shows a block diagram of the Property Offer Creation module, according to the present invention.

FIG. 7 shows a block diagram of the Registration/Login module, according to the present invention.

FIG. 8 shows a block diagram of the Map-Based Property Exploration module, according to the present invention.

FIG. 9 illustrates a startup page screen of a mobile application, according to the present invention.

FIG. 10 illustrates a screen of a mobile application for selecting an Add Offer service among other types of services, according to the present invention.

FIG. 11 illustrates a screen of a mobile application for selecting a property type, according to the present invention.

FIG. 12 illustrates a screen of a mobile application for selecting information related to a property, according to the present invention.

FIG. 13 illustrates a screen of a mobile application showing a map for selecting a location of a property, according to the present invention.

FIGS. 14-16 illustrate screens of a mobile application for entering a property specifications, according to the present invention.

FIG. 17 illustrate a screen of a mobile application for entering a building specifications, according to the present invention.

FIGS. 18-19 illustrate screens of a mobile application

for entering amenities of a property and audio/visual media featuring the property, according to the present invention.

FIG. 20 illustrate a screen of a mobile application for previewing an offer ad a property, according to the present invention.

FIG. 21 illustrate a screen of a mobile application for confirming approval and publication of an offer ad, according to the present invention.

FIG. 22 illustrates a screen of a mobile application for selecting a Buy Property service among other types of services, according to the present invention.

FIG. 23 illustrates a screen of a mobile application for selecting between an AR Property Exploration mode and a Map-Based Property Exploration mode, according to the present invention.

FIG. 24 shows a screen of a mobile application including AR icons/content appearing on the screen overlayed on top of an image or video capture by a smartphone's camera, according to the present invention.

FIGS. 25-35 show screens of a web-based version of the multifaceted real estate platform, according to the present invention.

Throughout the figures, the same reference numbers and characters, unless otherwise stated, are used to denote like elements, components, portions or features of the illustrated embodiments. The subject invention will be described in detail in conjunction with the accompanying figures, in view of the illustrative embodiments.

### DETAILED DESCRIPTION OF THE INVENTION

In general terms, the invention provides a platform and a method so that when someone is looking for a property, a mobile application is opened at the desired location and the smartphone is pointed in the direction of interest, so that the smartphone screen will display what the camera captures, along with existing property listings in augmented reality. The application combines geolocation and augmented reality providing a localized method of real estate prospecting with all the necessary information.

The invention allows users to input a real estate listing with common information such as but not limited to: property type, transaction type, price, area, age, number of bedrooms, number of bathrooms, floor, orientation, last renovation, energy diagnosis, photos, plans, and 3D tours. It also provides contact details for the real estate agent or the owner. Additionally, it enables users to browse listings in the traditional mode using an address or according to an embodiment of the invention, using augmented reality.

In the augmented reality mode, a user simply needs to point the camera of a smartphone towards the selected properties, and an icon with a summary of information will appear on the screen if there is a property for sale or rent in that direction. By clicking on this icon, all the provided information can be accessed in detail. Filters are also available to refine the search based on specific criteria related to property type and transaction type.

According to another embodiment of the invention, a website version is provided and replicates the functionalities of the mobile application except for the augmented reality viewing feature.

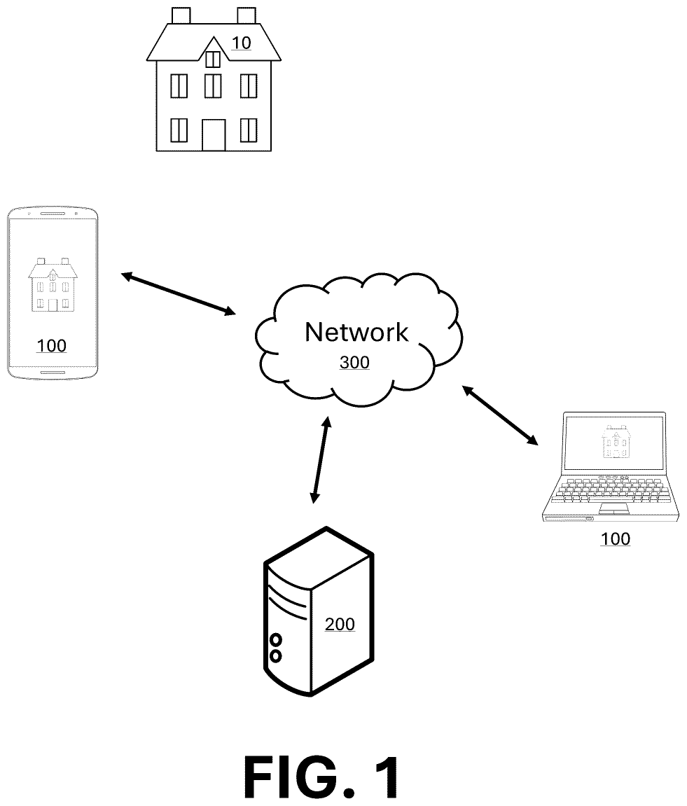

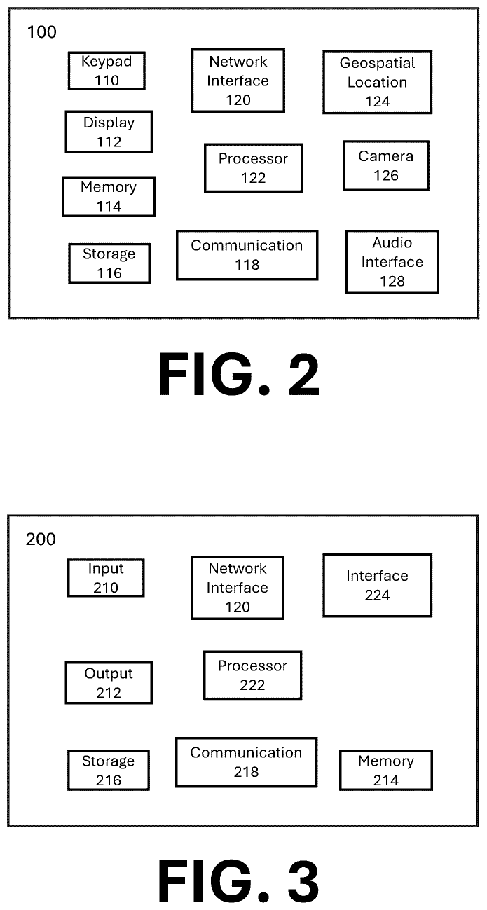

FIGS. 1-3 illustrate an exemplary embodiment for an augmented reality based multifaceted real estate platform, according to the present invention. The system may include one or more client devices 100, one or more servers 200, and a network 300 for allowing communication among the components of the system.

According to the invention, a client 100 is defined as any device configured to receive, process, store, and/or communicate information and/or data with other components of the system. Non-limiting examples of clients include a computer, a mobile computing device, a smartphone, a smart watch, an augmented-reality enable device, an electronic notebook, a Personal Digital Assistant (PDA), a tablet computer, and/or a laptop computer. The client 100 is provided with user interface components such as a display/touchscreen, camera, keyboard/keypad, and/or any other peripheral device configured to be connected to the client 100, such as but not limited to USB devices, Bluetooth-enabled devices, HDMI-enable devices, or any other wireless and/or wired device.

As shown in the accompanying figures, the client 100 includes one or more graphical user interfaces (GUI) that allows the user to interact with the augmented reality based multifaceted real estate platform of the invention. The GUI comprises at least one window or screen that includes the necessary interactive fields, pull-down lists, and buttons configured to: convey information and to be actuated by the user, display data received from the server and/or generated within the client device.

According to an embodiment of the invention, the client 100 is a mobile computing device at least including: a processor 122 (e.g., CPU), memory 114, storage 116, at least one network interface 120, an audio interface 128, a screen or display 112, a camera 126, a mechanical and/or virtual keyboard or keypad 110, wireless communication modules 118 (e.g., Bluetooth, WIFI, NFC, Cellular), and at least one geospatial location module 124 (e.g., global positioning systems (GPS)) which is used to determine the location of the user's mobile computing device, according to the present invention. One of ordinary skill in the art would understand that the mobile computing device can be a smartphone manufactured from APPLER or ANDROID® based phones that include other components that are well-known known in the mobile communications industry.

The audio interface 128 is configured to generate and/or obtain audio signals and may be connected to a speaker and microphone to enable telecommunication and/or generate audio indications. The screen or display comprises a liquid crystal display (LCD), a light emitting diode (LED) display, or any other type of display commonly used with a computing device. In a preferred embodiment, the screen or display includes a touch sensitive screen configured to receive input from a user via a stylus or a finger. The camera is a digital camera configured to capture still images and/or real-time video streams of external objects, scenery and, as will be explained below, real estate properties.

The network interface 120 comprises circuits, modules, and/or IC's that enable the user's mobile computing device to communicate with and connect to other components of the system using communication protocols and/or technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra-wide band (UWB), IEEE 802.16 Worldwide Interoperability for Microwave Access (WiMax), SIP/RTP, Bluetooth™, infrared, Wi-Fi, Zigbee, or any other wireless communication protocols. It should be understood that the network interface can provide unidirectional and/or bidirectional communication by way of a transmitter, a receiver and/or a transceiver.

The geospatial location module 124 comprises a GPS transceiver and associated circuitry that determines the physical coordinates of the user's mobile computing device, which are provided as latitude and longitude values. Alternatively, or in combination with GPS, the geospatial location module can also employ other geo-location technologies, including, but not limited to, triangulation, assisted OPS (AGPS), E-OTD, CI, SAI, ETA, or BSS. Alternatively, the client device may use other information, such as but not limited to a MAC address of the client device or an assigned IP address to determine the physical location of the device, alone or in combination with GPS.

The client device also contains memory means 114 including RAM and ROM, as well as other storage means 116. Memory means includes computer storage media for storage of information such as computer readable instructions, data structures, program modules or other data. The memory means may also include non-volatile memory, which can be embedded and/or may be removable. The non-volatile memory may additionally or alternatively include an electrically erasable programmable read-only memory (EEPROM), flash memory or the like.

Generally, the memory means stores “BIOS”, firmware, and an operating system, such as but not limited to UNIX, or LINUX™, IOS™, ANDROID™, or WINDOWS™. The operating system may also include, or interface with a Java virtual machine module that enables control of hardware components and/or operating system operations via Java application programs. In addition, memory means further includes one or more data storage that are used by the mobile computing device to store, among other things, applications, as in the preferred embodiment of the invention. Applications (e.g., mobile apps) include computer executable instructions which, when executed by the mobile computing device, transmit, receive, and/or process information and/or data.

According to an embodiment of the invention, the multifaceted real estate platform is implemented via at least one processor 122 and/or at least one memory means 114 and/or storage 116. The functionalities of the invention can be partially implemented via: hardware logic in the at least one processor and partially using the instructions stored in the memory means and/or storage, the at least one processor without additional instructions stored in the memory and/or storage, or the instructions stored in the memory and/or storage for execution by one or more processors 122. The invention is not limited to a specific configuration of hardware and/or software, wherein some functionalities can be implemented, at least in part, in software. Thus, the functionalities can be performed in a computing system or other data processing system in response to its processor, such as a microprocessor, executing sequences of instructions contained in a memory, such as ROM, volatile RAM, non-volatile memory, cache or a remote storage device. At least one computer readable storage medium is used to store software and data which when executed by at least one processor causes the system to perform various methods. The executable software and data may be stored in at least one storage means such as but not limited to ROM, volatile RAM, nonvolatile memory and/or cache. Portions of this software and/or data may be stored in any one of these storage devices.

The network can be any well-known interconnecting system capable of transmitting audio, video, signals, data, messages, or any combinations thereof, and may include without limitations all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

A server 200 may be any suitable combination of hardware and/or software implemented in one or more modules to process data and provide the functions and operations, according to the invention. In some embodiments, the functions and operations described herein may be performed by more than one server. As will be understood by one of ordinary skill in the art, a server may include, without limitation, a mainframe, server, host computer, workstation, web server, file server, cloud computing cluster, a personal computer such as a laptop, or any other suitable device operable to process data. The server may execute any suitable operating system such as IBM's z Series/Operating System (z/OS), MS-DOS, PC-DOS, MAC-OS, WINDOWS, UNIX, OpenVMS, or any other appropriate operating systems. The server may include a processor, server memory, an interface, an input, and an output. A server memory can be any suitable device capable of storing and facilitating retrieval of data and/or instructions such as, but not limited to, RAM, ROM, mass storage media (e.g., a hard disk, solid state drive), removable storage media (e.g., CD, DVD), database and/or network storage, and/or or any other volatile or non-volatile, non-transitory computer-readable memory devices that store at least one file, list, table, or other arrangements of information. The server memory can be internal and/or external to the server, and may be separate from or integral to other memory devices to achieve any suitable arrangement of memory devices for in accordance to functionalities of the invention.

The server memory is generally operable to store a program or application and data. According to the invention, application refers to logic, rules, algorithms, code, tables, and/or other suitable instructions for performing the functions and operations of the invention. In some embodiments, the application process facilitates determining information provided to the client device. For example, as will be explained in detailed below, the application may interact with the client device, to determine a real estate property viewed through the camera of client device and to provide information about the real estate property to the client device. Data may include data associated with user such as login information, buying and selling preferences, as well as information associated with real estate properties such as, but not limited to floor plans, layouts, property size, property type, price information, and data regarding whether a property is for sale.

The server memory communicates to a processor operable to execute the program or application stored in the server memory according to the invention. The processor may comprise any suitable combination of hardware and software implemented in one or more modules to execute instructions and manipulate data to perform the functions and operation for the server. In some embodiments, the processor may include one or more computers, one or more central processing units (CPUs), one or more microprocessors, one or more applications, and/or other logic.

A communication interface is generally connected to the processor and may be any suitable device operable to receive inputs for the server, send outputs from the server, perform suitable processing of the inputs or outputs or both, communicate to other devices, or any combination thereof. The communication interface may include appropriate hardware (e.g., modem, network interface card, etc.) and software, including protocol conversion and data processing capabilities, to communicate through the network or other communication system, which allows the server to communicate to other devices. The communication interface may include any suitable software operable to access data from various devices such as client devices, and/or network storage, as well as any suitable software operable to transmit data to various devices such as client devices. The communication interface may include at least one port, conversion software, or both to receive and transmit information from client devices, and/or network storage.

According to an embodiment of the invention, a network storage is provided for storing and facilitating retrieval of data and/or instructions, where the network storage may be any suitable device communicatively coupled to the network. Some non-limiting examples of the network storage include computer memory, RAM, ROM, mass storage media (e.g., a hard disk, solid state drive), removable storage media (e.g., CD, DVD), database and/or network storage, and/or or any other volatile or non-volatile, non-transitory computer-readable memory devices that store at least one file, list, table, or other arrangements of information. In an embodiment, the network storage can store any data and/or instructions utilized by the server. In particular, the network storage may store information associated with a real estate listing service such as a Multiple Listing Service (MLS) information, property data, data associated with an address of a property, floor plans, layouts, property size, property type, and price information associated with an address, data regarding whether a property is for sale. It is important to understand that some or all of the above data and/or information can be provided on the server memory, the network storage, or a combination of both. It is also envisioned that the network storage can be provided external to the server, internal to the server, or a combination thereof.

According to an exemplary implementation of the invention, the multifaceted real estate platform integrates the following technologies:
FLUTTER™: An open source framework by GOOGLE® providing a flexible framework for crafting natively compiled applications for mobile, web, and desktop from a single codebase. Used for building the mobile application interface.
UNITY®: A video/image rending technology from UNITY TECHNOLOGIES™. It is integrated with FLUTTER through a UNITY widget plugin and enables the augmented reality features of the application, using its rendering engine to manage 3D graphics and AR elements.
NODE.JS®: A JavaScript runtime environment used to build the backend API that handles data validation, error management, and interaction with the POSTGRESQL database.
POSTGRESQL®: A relational database management system that stores all the application data securely, including user information and property details.
GOOGLE Maps/MAPBOX® SDK: Geographic mapping library and platform integrated into the FLUTTER app to provide map-based property exploration features.
GOOGLE ARCORE™: Augmented reality SDK from GOOGLE offering cross-platform APIs used within the UNITY environment to handle Augmented Reality (AR) capabilities, including tracking and geospatial data integration.
ARCORE Geospatial API: The part of GOOGLE ARCORE specifically provided for its ability to place AR content accurately in a real-world context based on geospatial data.

According to an embodiment of the invention, the multifaceted real estate platform comprises a system architecture that is divided into three main components:
FLUTTER Application: This is the primary interface for users that handles user interactions, data inputs, and display of information. The application connects to the NODE.JS backend via RESTful APIs, which are architectural styles for an application programming interface that uses HTTP requests to access and use data, for data validation and retrieval.
UNITY Project: This component is Integrated into the FLUTTER application through a dedicated plugin and manages all AR-related functionalities. Uses ARCORE for real-world integration of digital content, providing users with interactive, spatially aware AR experiences.
NODE.JS Backend: This component processes incoming data from the FLUTTER app, performing validation and handling errors. It Interacts with the POSTGRESQL database for data storage and retrieval and directs data back to the FLUTTER and UNITY applications based on user requests and interactions.

A user submits real property data through the FLUTTER app, which is then sent to the NODE.JS backend for validation. Upon successful validation, the data is stored in the POSTGRESQL database. If validation fails, an error message is sent back to the FLUTTER app to inform the user. When using the AR functionality, the UNITY project requests location and device orientation data from the user's device. Based on this data, UNITY queries the NODE.JS backend for nearby properties, receives the data, and places corresponding AR content in the user's real-world environment. When a user interacts with an AR object, the UNITY project communicates the user's selection back to the FLUTTER app via the UNITY_widget plugin. This enables the FLUTTER app to display detailed property information, thereby integrating the AR experience with traditional application functionalities.

As previously explained, the invention provides a real estate platform that can be used by all the individuals and entities involved in the real estate market. Accordingly, the platform has the following requirements and features.

### User Types and Roles

### Seller and Buyer:

Users register on the platform as either sellers or buyers, providing all the necessary information such as name, contact details, and preferences.
Sellers create listings for their ‘real estate properties, uploading to the server information such as but not limited to price, location, images, and descriptions. This data is submitted from the client device (e.g., through the Flutter app) and sent to the server (e.g., Node.js backend) for validation against predefined criteria (e.g., completeness, format). If the data passes validation, it is stored in the PostgreSQL database. Otherwise, the server returns an error code and a message is sent to the client device so that the application informs the user of the specific issue.
Buyers explore properties using two primary methods: Map Exploration and Augmented Reality Exploration. During map exploration, users can select a geographical area on a map (e.g., Google Maps SDK integrated into the Flutter app) to view available properties that fit the selected criteria. During augmented reality exploration, users explore properties through Augmented Reality (e.g., using Unity and Google ARCore) where properties are visually anchored in the real world based on the user's location and device orientation.

### Real Estate Entity/Agency:

Entity/Agency accounts have the ability to create and manage subaccounts for their employees. This includes viewing, updating, and deleting listings created by their employees.
Entities/Agencies are provided with advanced tools for managing property listings on a larger scale, including bulk uploads and edits.

### Property Listing and Validation Process

Sellers submit data by inputting property details into the application (e.g., Flutter app), which includes data such as but not limited to address, price, property type, videos and photos.
Backend Validation: The Node.js API receives the data and performs validation checks ensuring that all required fields are filled, formats are correct, and data is consistent.
Database Storage: Once validated, that data is stored in the PostgreSQL database where the system assigns a unique ID to each property for easy retrieval and reference.
Error Handling: If there are issues with the data (e.g., missing information, format errors), the server responds with an appropriate error code and a descriptive message, which the application (e.g., Flutter app) displays to the user in order to correct the issue.

### Property Exploration Methods

### Map Exploration:

Users navigate a map interface within the Flutter app (e.g., via integration with Mapbox SDK) to locate properties. The app queries the PostgreSQL database via the Node.js backend to fetch properties based on the geographic criteria set by the user.

### Augmented Reality Exploration:

Real-time geospatial data of the client device is accessed to place digital content accurately in the real world. In an embodiment of the invention, this is done with the ARCore Geospatial API, where Unity is equipped with ARCore.
Geospatial Anchors: Properties are anchored using precise latitude, longitude, altitude, and orientation data (e.g., Coordinates: X, Y, Z). Unity calculates this information using the ARCore Geospatial API and additional data (e.g., EGM96) for altitude corrections.
Interaction with AR Content: Users can interact with 3D models of properties that display key information such as, but not limited to images, price, and a short description. Detailed views are accessible by tapping on the AR objects shown on the screen, which triggers communication within the app (e.g., between Unity and Flutter) to display full property details on the app.

As previously explained, the invention provides an improvement to traditional real estate platforms enhancing the user interactions by the integration of AR technology.

According to an embodiment of the invention, the multifaceted real estate platform is used in a mobile device environment where Google ARCore and the Geospatial API are provided to implement the AR according features to the invention. Specifically, Google ARCore is the platform used for building the augmented reality application and provides three key capabilities: 1) motion tracking, 2) environmental understanding, and 3) light estimation. The Geospatial API enhances ARCore by providing geospatial context using Google's mapping data by anchoring AR content to real-world locations with high precision by using data from Google Maps and Street View. This approach allows users to interact with their environment, enabling experiences that blend digital and physical worlds seamlessly.

One important aspect of the invention is that the mobile application seamlessly integrates AR in exploring real estate properties. This integration of AR using Unity and Google ARCore allows users to visualize properties in their actual geographic context through their mobile devices, offering a more immersive and interactive property exploration experience. Using ARCore's Geospatial API, the application places 3D models of properties precisely in the real world, anchored to specific geographical coordinates (X, Y, Z). This functionality transforms the user's environment into an interactive display where digital and physical worlds converge, providing a vivid and informative property viewing experience. Users can interact directly with the 3D models by tapping them on the screen, which brings up detailed information or redirects the user to more comprehensive property details in the application. This seamless integration between AR and a traditional app interface enhances user engagement and decision-making.

In order to achieve high precision location

functionality, the application employs an innovative approach to ensure the accuracy and reliability of property placement in AR. In a preferred embodiment, the Unity app sets a 9-meter threshold for horizontal accuracy provided by the ARCore Geospatial API. This threshold ensures that the placement of AR content remains precise, only activating the AR features when the device's location data is within this accuracy range. It should be noted that other distance thresholds can be set. To refine the altitude data necessary for correct 3D placement, the app uses interpolation from the Earth Gravitational Model 1996 (EGM96), which is a spherical harmonic model of the Earth's gravitational potential complete to degree and order 360. This model provides a detailed grid of values to calculate the height of the geoid above the WGS84 ellipsoid, enhancing the vertical positioning accuracy of the AR content.

The detailed property information presented in AR is not only visually engaging but also interactive, offering a user-friendly interface to access property details. Each AR property model displays essential information such as but not limited to the main picture of the property, price, title, and a short description, providing a quick overview directly in the user's immediate physical context. For more detailed information, the AR interface allows for direct interaction, where tapping an AR object on the screen triggers a query that fetches and displays full property details from the backend server. This feature integrates tightly with the Flutter application, enabling a smooth transition from AR viewing to detailed property analysis on the app.

The combination of these aspects enhances the practical utility of the real estate platform of the present invention. By merging AR technology with traditional real estate browsing methods, the platform offers a unique and enriched user experience that goes beyond simple property listings improving how properties are explored and evaluated by potential buyers and sellers.

The technical implementation details will be discussed to understand how the features of the invention are achieved through the integration of various technologies and system components.

### ARCore Geospatial API Usage

According to an embodiment of the invention, the augmented reality features of the application are powered by Unity, using the ARCore Geospatial API for precise geolocation capabilities. This API enables the app to anchor digital content in the real world at specific geographic coordinates, providing users with an immersive AR experience that accurately represents property locations. The Unity app continuously monitors the state of the ARCoreSession to check device compatibility and the availability of the Geospatial API features. It ensures that the tracking information, essential for accurate AR content placement, is reliable and accurate. Moreover, essential geospatial data such as latitude, longitude, altitude, and horizontal accuracy are acquired from Google's Geospatial API. This data forms the basis for placing geospatial anchors at precise real-world locations.

### Communication Between Unity and Flutter

The integration between the Unity engine and the Flutter application is facilitated by the unity_widget plugin, which enables bidirectional communication. This communication allows for data exchange between the two platforms, enabling user interactions with AR content to trigger actions within the Flutter app, such as displaying detailed property information. The plugin supports a seamless transition between AR interactions in Unity and traditional application interfaces in Flutter, maintaining a consistent and fluid user experience across both environments.

### Backend Interactions

The Node.js backend plays a critical role in data management, validation, and serving content to both the Flutter and Unity components of the application. As property data is submitted through the Flutter app, the backend validates this data according to predefined rules. Validated data is then stored in the PostgreSQL database. When the Unity app determines that the user's location has sufficient accuracy and the user has initiated an AR session, it requests property data from the backend. The backend retrieves relevant property information from the database based on proximity of user's location and sends it back to Unity for AR presentation.

### Enhanced Geospatial Calculations

The application uses mathematical models and algorithms to enhance the accuracy and relevance of the AR content. To compute the precise altitude of properties, the app interpolates values from the Earth Gravitational Model 1996 (EGM96), adjusting the altitude data obtained from standard geolocation services to reflect more accurate topographical elevations. Orientation data is crucial for the correct presentation of 3D models in AR. The app extracts orientation from the Geospatial Pose and converts it into a quaternion. This quaternion represents the rotation matrix, transforming a vector from the target location to the east-up-north (EUN) coordinate system, ensuring that AR content is oriented correctly with respect to the real world.

These technical implementations are fundamental to delivering the innovative features of the real estate platform according to the invention. They ensure that the application not only provides a novel property viewing experience through AR but also maintains high standards of data integrity and user interaction quality.

User interaction and experience design will be explained detailing how users engage with both the conventional and AR features of the app, ensuring accessibility, usability, and satisfaction.

### User Interface

The application's user interface (UI) is designed to be intuitive and accessible, catering to a diverse user base with varying levels of technological proficiency. It seamlessly integrates the traditional aspects of real estate browsing with innovative AR functionalities, providing a cohesive and engaging user experience. The Flutter portion of the application features a clean, user-friendly interface that allows users to easily navigate through property listings, manage their accounts, and interact with the system. Features such as search filters, property details, and user settings are laid out in an accessible manner. In the Unity-driven AR experience, the interface maximizes the immersion of real-world interactions. Information about properties is displayed as part of the AR overlay, with intuitive touch gestures enabled for interacting with AR elements.

### User Experience Flows

The application supports distinct user experience flows

for both sellers/buyers and real estate agencies, optimized to accommodate their specific needs and activities within the platform.

### Seller/Buyer Flow:

Users register and log into the app, with the option to identify as a seller or a buyer. Sellers enter details of their property into a form, submit it for validation, and upon successful posting, view their listing live on the platform.

For a map-based search, buyers use the map feature of the application to find properties in desired locations. For an AR-based search, buyers activate AR mode, granting necessary permissions, and exploring properties through AR overlays that provide real-time, spatially accurate property visuals. Users can tap on AR property models to interact with the property and view detailed information or initiate contact with sellers through the app.

### Real Estate Agency Flow:

Agencies manage their own profiles and can create subaccounts for employees. Agencies view and manage listings made by their employees, with the capability to edit or delete listings as necessary. Advanced search and bulk management tools are provided to handle multiple properties efficiently.

### Accessibility and Usability Enhancements

The design and development of the application have emphasized accessibility to ensure that all users, regardless of physical ability or familiarity with technology, can effectively use the platform. Settings such as but not limited to text size options, voice commands for navigation, and high-contrast visual elements are provided to make the app more accessible to users with visual impairments or limited manual dexterity.

As can be appreciated, the user interactions and experiences provided according to the invention, are crucial in ensuring that the application not only meets the functional requirements of real estate exploration and management but also provides a pleasant and engaging experience for all users. The integration of AR technology, coupled with a traditional interface, creates a dynamic platform that enhances real estate property exploration.

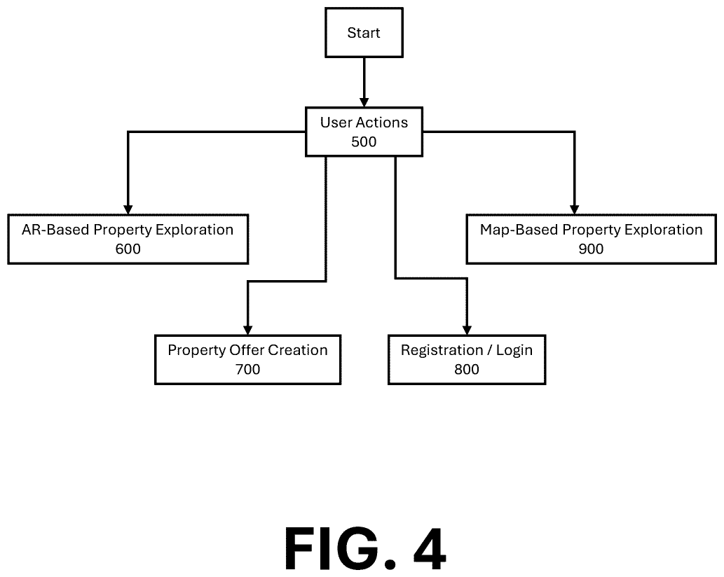

As shown in FIG. 4, the application initiating its launch sequence when a user opens the app. At this stage, the Flutter app initializes all necessary components and prepares the user interface for interaction. The app ensures that all initial settings are configured, and it readies the application for subsequent user actions. The primary decision point 500 is where the user selects an intended action. At this stage, the user is presented with various options within the application, such as exploring properties through augmented reality (AR), creating property listings, logging in or registering, and exploring properties using a map-based interface. The selected action will determine the subsequent flow and functionalities activated within the app. Module 600 provides augmented reality-based exploration of properties on the app using Unity and Google ARCore. This module uses ARCore's capabilities to provide users with an immersive experience by overlaying virtual property models onto the real-world environment. Users can view and interact with 3D representations of properties in their actual locations, enhancing the property exploration process through precise geospatial mapping and real-time data integration. Module 700 enables users to create property listings through the application. Users can input detailed information about properties, including descriptions, photos, specifications, and pricing. The app provides an intuitive interface for entering and managing property data, ensuring that all necessary details are accurately captured. Once the information is submitted, it is sent to the server for storage and made available for potential buyers or renters to view. This feature streamlines the process of listing properties, making it accessible and efficient for users. Module 800 manages user authentication within the application, including both registration for new users and login for existing users. During registration, users can choose to sign up as either professionals (e.g., real estate agents) or individuals, providing the necessary personal and contact information. The login process allows returning users to access their accounts by entering their credentials. User data is securely transmitted to and stored on the server, ensuring secure and seamless access to the app's features and personalized settings. This module is critical for user management and access control within the application. Module 900 allows users to explore properties using a map-based interface within the application. Users can search for properties based on their current location or by entering a specific address. The app converts address inputs into geographical coordinates and retrieves relevant property data from the server. In a preferred embodiment, the MapBox SDK is utilized to display the properties on an interactive map, providing a visual and intuitive way for users to locate and examine available properties. This feature enhances the user experience by offering a geographical context and easy navigation through the listed properties.

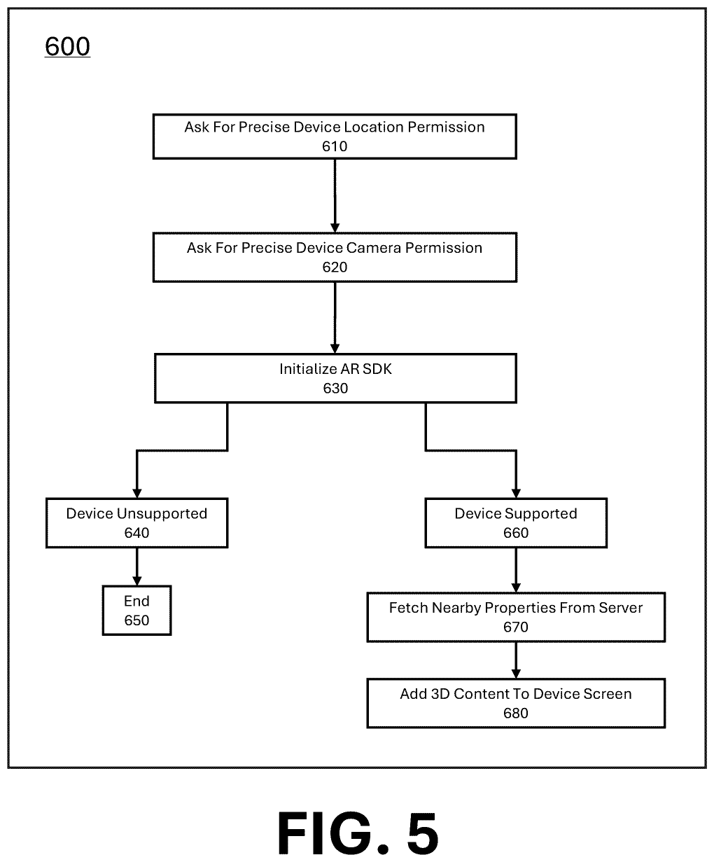

FIG. 5 illustrate in more detail the processes involved in the AR-based property exploration module 600. At step 610, the application requests permission to access the user's precise location data, which is critical for accurate geospatial mapping in augmented reality (AR). This permission ensures that virtual property models are accurately anchored to their real-world coordinates, enhancing the user's AR experience and ensuring precise location-based interactions. At step 620, the application requests permission to use the device's camera, which is necessary for capturing the environment from a field of view of the camera and overlaying augmented reality (AR) content. This permission enables AR functionality by allowing the app to analyze real-world surroundings and accurately place virtual objects within the field of view of the camera of the client device, creating an immersive AR experience. The Google ARCore SDK is then initiated at step 630. The Geospatial API uses Google's Visual Positioning Service (VPS), which uses imagery from Google Street View. This service has indexed trillions of 3D points from these images, creating a detailed model of the world. When the API is initialized, it matches the real-time images captured by the device's camera to this pre-existing model to determine the device's exact location and orientation in less than a second. The ARCore Geospatial API integrates various device sensors to achieve accurate localization:
Camera: Captures the environment and matches the visual data against the VPS database.
GPS: Provides rough geographical location data (latitude, longitude, and altitude) which is refined using VPS.
IMU (Inertial Measurement Unit): Combines accelerometer and gyroscope data to track the device's orientation and movement. This data assists in stabilizing the AR content and ensuring smooth transitions as the device moves.
Magnetometer: Assists in determining the device's heading relative to the Earth's magnetic field, which can be useful in refining orientation.

It should be noted that the data obtained by the sensors can be obtained in any particular order. The API employs advanced machine learning techniques to process the sensor data and visual information. This helps in aligning the device's position and orientation with the global model created from Street View images, enabling the AR content to be anchored accurately in the real world. Once initialized, the API continuously processes input from the sensors to maintain and update the device's position and orientation. This ensures that the AR content remains accurately placed even as the user moves around. AR content is anchored to specific geographical coordinates (latitude, longitude, and altitude). This allows the AR elements to appear consistently at the same real-world locations, regardless of where the user is starting from or how they move around the space. Essentially, the ARCore Geospatial API utilizes a combination of visual data from the device's camera, GPS for initial location, IMU for motion tracking, and magnetometer for orientation, all processed and refined through machine learning against Google's extensive Street View data to provide accurate and immersive AR experiences.

If the device supports ARCore, the application proceeds at step 660 with augmented reality (AR) functionalities. This determination ensures that users with compatible devices can fully experience AR-based exploration features within the application. By using ARCore's capabilities, the app delivers immersive AR experiences, enhancing user engagement and interaction with virtual property models anchored to real-world coordinates. This continuation ensures a seamless user experience for supported devices. Once the application determines that the device is supported, the application monitors the horizontal accuracy (provided by the AREarthManager.CameraGeospatialPose) at step 670. If the horizontal accuracy is smaller than the threshold set by the application (e.g., 9 meters), the application proceeds to fetch nearby properties from the server within a specified radius (e.g., 50 meters). However, if the horizontal accuracy does not meet the threshold, the application continues to wait until the accuracy improves to an acceptable level. This approach ensures that property data is retrieved only when the location accuracy meets the application's criteria, optimizing the user experience and ensuring the reliability of location-based features. Then, at step 680, 3D content representing property offers is added to the device screen within the augmented reality (AR) environment. Each 3D object is equipped with an onClick event handler, allowing users to interact with the virtual objects. When a user clicks on a property offer, the unique identifier (ID) of the clicked offer is sent from the Unity project to the Flutter project. This communication is facilitated through the unity_widget, a Flutter plugin that enables seamless integration between Unity and Flutter applications. Upon receiving the offer ID, the Flutter project can retrieve and display detailed information about the selected property offer, enhancing the user's engagement and facilitating informed decision-making.

If the device does not support AR functionality (e.g., ARCore), the AR-based exploration process is terminated at step 640 and ends at step 650. This step ensures compatibility and prevents errors on devices that do not meet the required hardware or software specifications for running ARCore applications. By appropriately unsupported devices, the application handling maintains a seamless user experience and avoids potential technical issues or performance limitations.

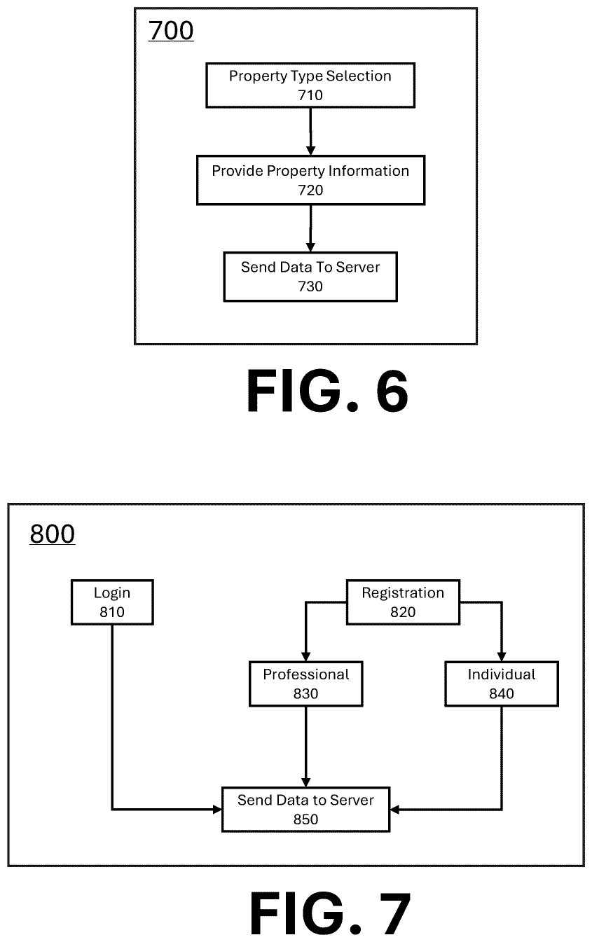

FIG. 6 illustrates in more detail the processes involved in the property offer creation module 700. At step 710, users are presented with options to select the type of property they intend to list. This includes categories such as residential, commercial, industrial, or others, depending on the application's offerings. Users can make their selection based on their specific property type, indicating their intention to list properties of a particular category. This step streamlines the property listing process by allowing users to categorize their listings effectively, ensuring that they are appropriately classified for potential buyers or renters to browse and discover the properties. At step 720, users input comprehensive details about the property they wish to list. This encompasses a range of information including textual descriptions, accompanying photographs, and specifications. Users may provide a narrative description highlighting key features, amenities, and unique selling points of the property. Additionally, they can upload photographs showcasing different areas and aspects of the property to visually complement the description. Specifications such as but not limited to size, dimensions, number of rooms, amenities, and any additional relevant details are also entered to provide comprehensive information to potential buyers or renters. This step ensures that the property listing is informative and attractive, facilitating informed decision-making for interested parties. Upon completion of property information entry, the data entered is transmitted to the server at step 730 for storage and subsequent retrieval. This process involves securely sending the gathered details, including descriptions, photographs, specifications, and any additional information, to the designated server endpoint. The server stores the property data in a structured format, associating it with the respective user account or property listing. This ensures that the entered information is securely archived and readily accessible for future reference or interaction, facilitating seamless management and retrieval of property listings within the application.

FIG. 7 illustrates in more detail the processes involved in the registration/login module 800. At step 810, users log in and gain access to their personalized profiles and the full suite of application features. Through the login interface, users provide their previously registered credentials, typically comprising a username or email address and a password. Upon successful authentication, users are granted access to their individual profiles, along with any associated preferences, saved data, or customized settings. Additionally, authenticated users can seamlessly navigate through various sections of the application, accessing features such as but not limited to property listings, saved searches, notifications, and account management functionalities. This step ensures a secure and personalized user experience tailored to each authenticated user's needs and preferences. New users initiate the registration process at step 820 to create an account within the application. During registration, users provide necessary information such as their name, email address, and a secure password. This step ensures that new users can establish their presence within the application ecosystem, enabling them to access personalized features and functionalities.

As previously explained, there are two main types of users: real estate professionals and individuals that can be sellers or buyers. The registration option at step 830, caters specifically to professionals in the real estate industry, such as real estate agents or brokers. Professionals can sign up for an account tailored to their professional needs, allowing them to access specialized tools, features, and resources designed to support their business activities within the application. Individual users, including prospective buyers or renters, opt for registration at step 840 to create a personalized account tailored to their individual preferences and requirements. By registering as an individual user, individuals gain access to a range of features and functionalities geared towards facilitating their property search, exploration, and interaction within the application. Upon completion of registration or login, user data is securely transmitted to the server at step 850 for storage and processing. This includes essential user information such as account credentials, profile details, and any additional preferences or settings specified by the user. The server validates and stores the received user data in a secure database, ensuring the integrity and confidentiality of user information. This step enables seamless synchronization of user accounts across multiple devices and facilitates personalized user experiences tailored to individual preferences and interactions within the application.

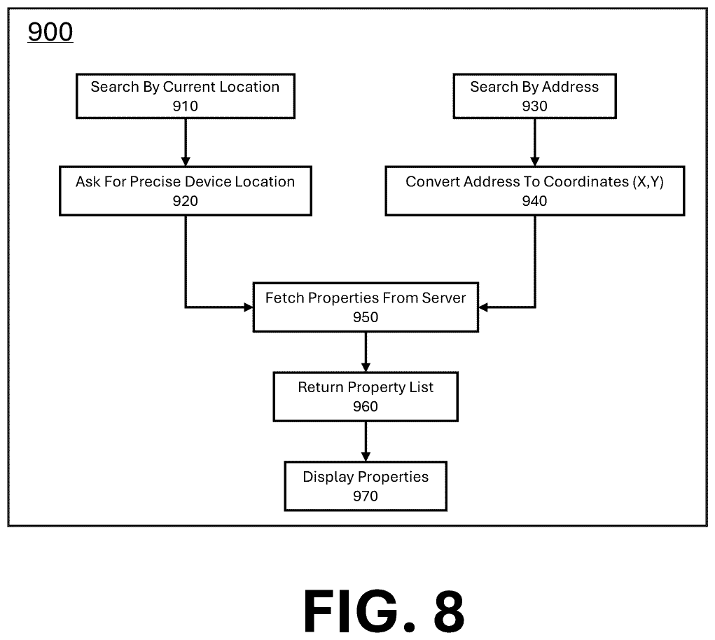

FIG. 8 illustrates in more detail the processes involved in the map-based exploration module 900. Users have the option to search for properties based on their current geographic location at step 910. By using the device's GPS capabilities, the application identifies the user's current position and initiates a property search within the vicinity, providing convenient access to nearby property listings. To enable location-based search functionalities, the application requests permission at step 920 to access the user's precise location. This ensures accurate positioning and enhances the effectiveness of property searches based on the user's current geographical coordinates. Alternatively, users can search for properties by entering a specific address of interest at step 930. This feature allows users to target properties in a particular location, catering to their specific preferences or requirements. Upon entering an address, the application converts the provided address into geographical coordinates (X, Y) at step 940 for mapping purposes. This conversion facilitates precise location-based searches and ensures accurate placement of property listings on the map interface. Property data corresponding to the user's search criteria, whether based on current location or entered address, is fetched from the server. This data retrieval process ensures that users receive up-to-date and relevant property listings that match their search parameters. The application compiles a list of properties that meet the search criteria specified by the user and this property list is returned to the user at step 960, enabling them to browse and explore available listings conveniently. The properties from the retrieved list are displayed on the client device on a map interface using the MapBox SDK. This interactive map provides users with a visual representation of property locations, allowing for intuitive exploration and navigation. As previously explained, users can interact with property markers on the map to access additional details and make informed decisions regarding property selection.

As previously explained, the multifaceted real estate platform can be provided as a website version replicating the same functionalities of the mobile application except for the augmented reality viewing feature.

According to an embodiment of the invention, the website version is implemented using a web server built with Node.js that cater to web visitors and provides them with a CRUD API to fetch and create real estate data. A second server, built with Node.js, handles back-office operations and offers functionalities such as viewing charts of property views, new announcements, and managing the acceptance or rejection of new property listings. PostgreSQL is used to store property data and Redis (a source-available, in-memory storage, used as a distributed, in-memory key-value database, cache and message broker) is used for handling asynchronous tasks. The entire application is containerized using Docker (a set of platform as a service (PaaS) products that use OS-level virtualization to deliver software in packages called containers) providing scalability and ease of deployment. A Frontend app, built with Nextjs (an open-source web development framework providing React-based web applications with server-side rendering and static website generation) has several features like creating an account, signing in, creating an announcement (the back office can automatically accept the offer currently by running a schedule every 2 minutes), and discovering existent offers.

Embodiments of the present invention may be implemented in hardware, firmware, software, or any combination thereof. Embodiments of the present invention may also be implemented as instructions stored on a machine-readable medium. These are readable and executable by one or more processors. A machine-readable medium includes any mechanism for storing or transmitting information in a form readable by a machine (e.g., a computing device).

For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it is acknowledged that such descriptions are merely for convenience. Such actions in fact result from computing devices, processors, controllers, or other devices executing the firmware, software, routines, instructions, etc. The machine-readable medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this specification, a computer readable storage medium may be any non-transitory, tangible medium that can contain, or store a program for use by or in connection with an instruction execution system, apparatus, or device. Storage and services may be integrally included with the client device, the server or remote such as in the “cloud”.

It is also envisioned that the at least one processor, the at least one memory/computer readable storage medium or both can be integrated into the client device, the server or both. Alternatively, the at least one processor, the at least one memory/computer readable storage medium or both can be provided on a separate computing station, such as but not limited to, a computer desktop, a laptop, tablet or a smartphone. As is well understood in the art, additional components, such as but not limited to, input/output peripherals, audio/video cards, power supplies, wireless and wired network cards, can also be provided or required in conjunction with the at least one processor and the at least one computer readable storage medium to perform the steps, acts or operations of the present invention.

According to an embodiment of the invention, all the steps, acts or operations are performed using the same processor and the same memory/computer readable storage medium. In another embodiment, some of the steps, acts or operations are performed using one processor while other steps, acts or operations are performed using a different processor. For example, one processor can execute the instructions to perform the steps, acts or operations of AR property searching while a different processor can execute the instructions to perform the steps, acts or operations of storing and retrieving data from the server. In addition, it is also envisioned that instructions for performing some of the steps, acts or operations are stored in one computer-readable storage medium and instructions for performing other steps, acts or operations are stored in another computer-readable storage medium. For example, one computer-readable storage medium can store instructions that when executed by a processor performs the steps, acts or operations of AR property searching and another computer-readable storage medium can store instructions that when executed by a processor performs the steps, acts or operations of storing and retrieving data from the server.

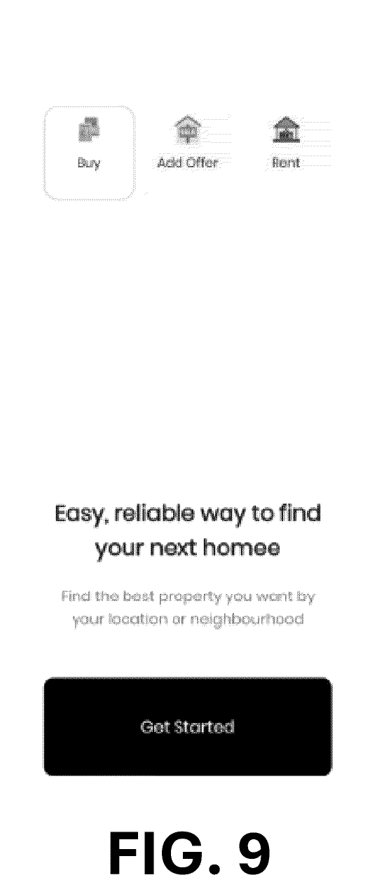

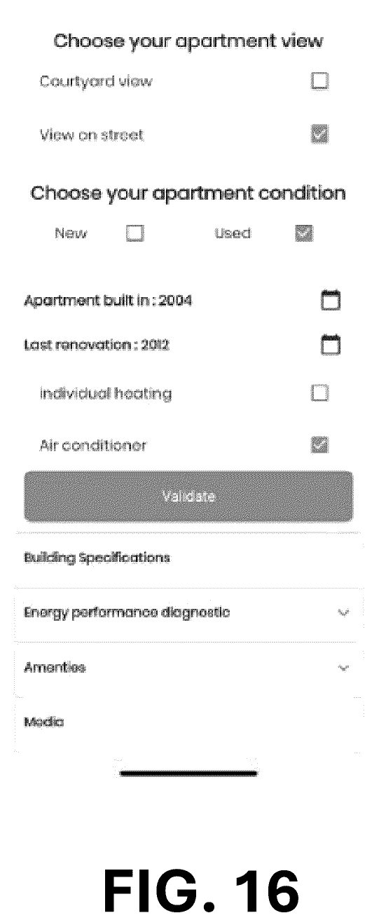

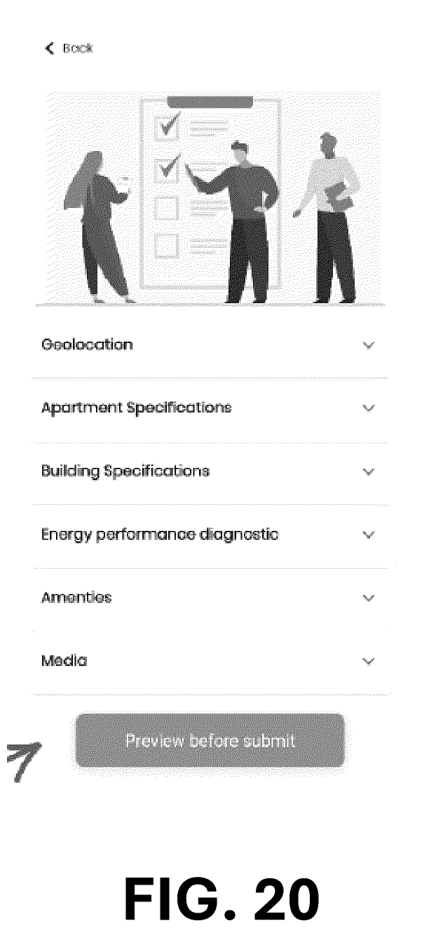

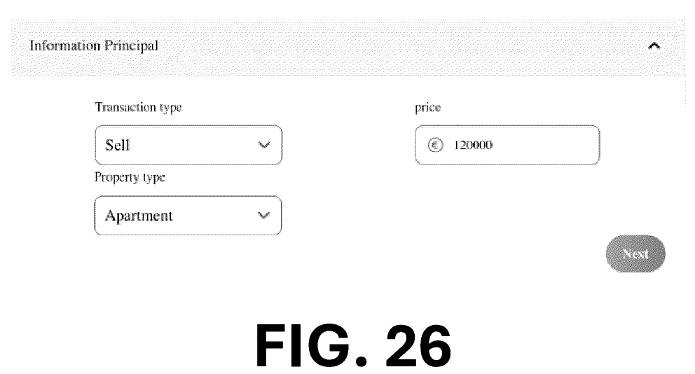

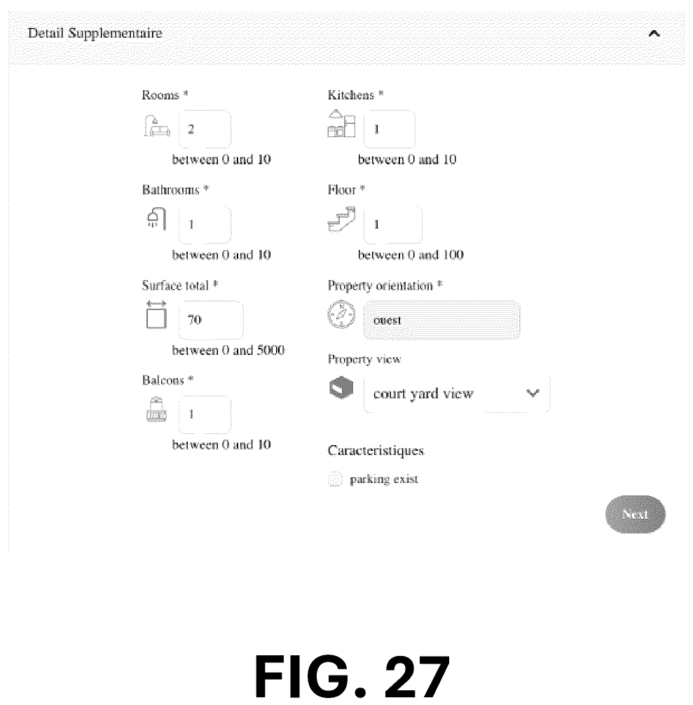

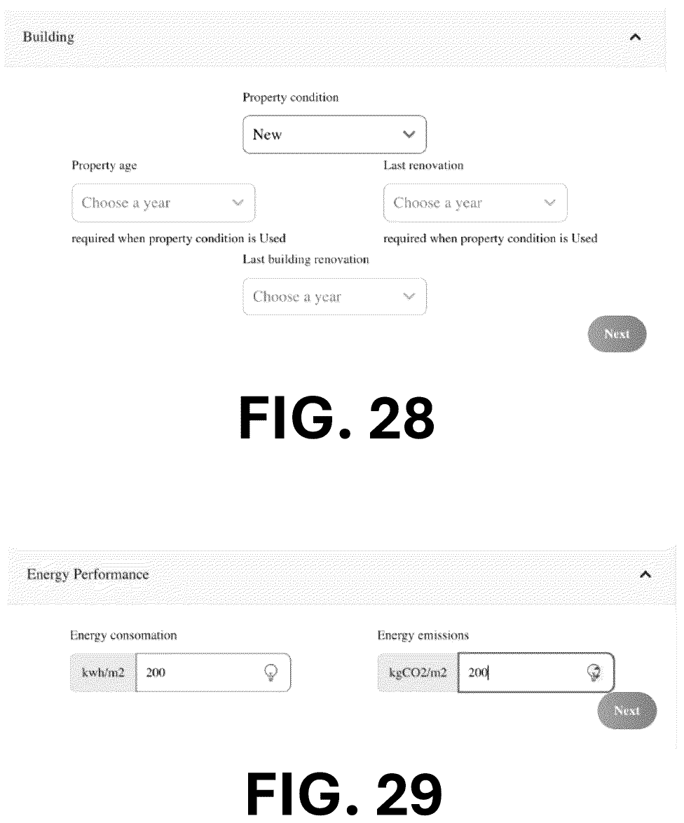

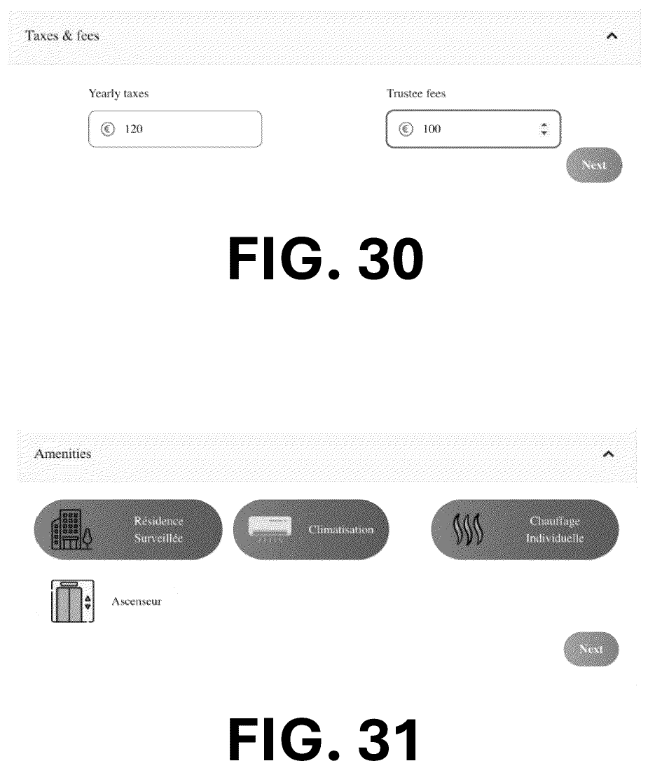

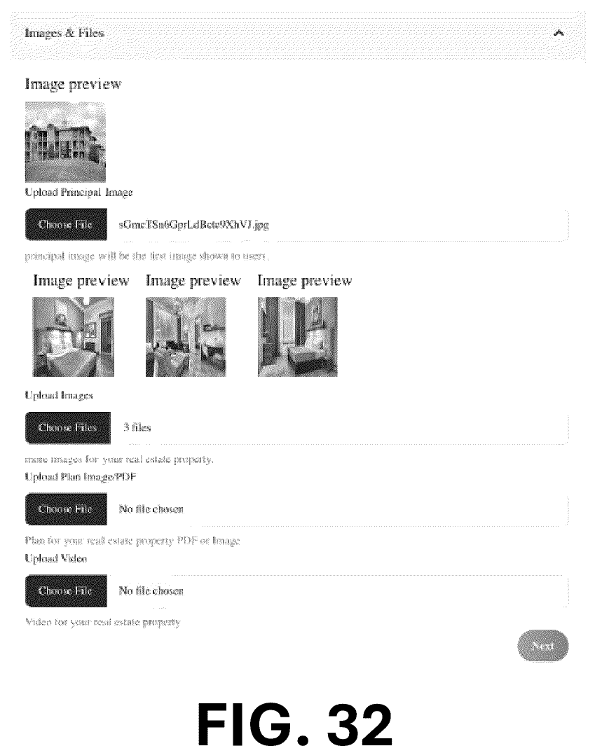

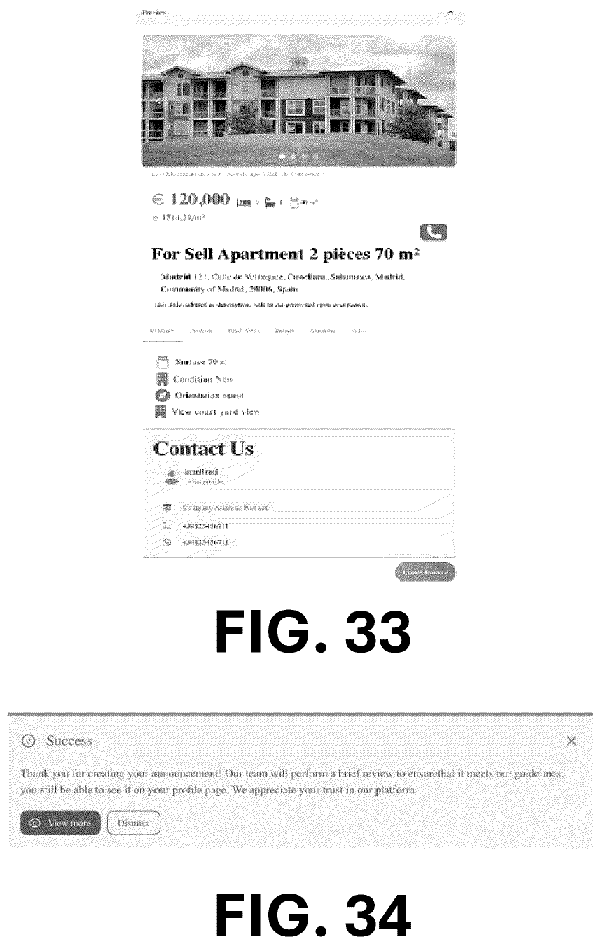

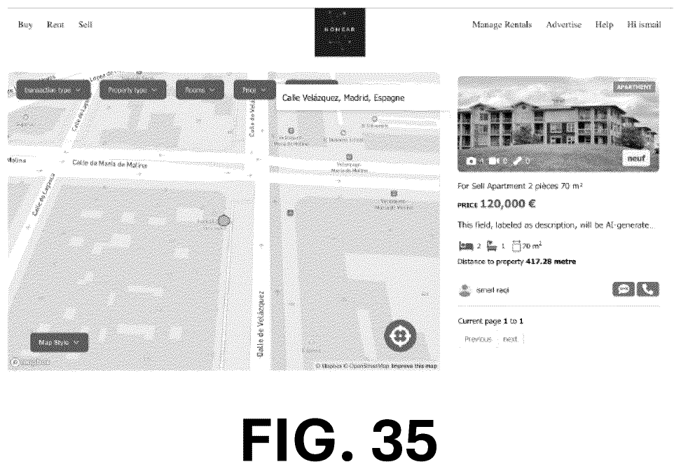

A preferred embodiment of the invention will be described in conjunction with FIGS. 9-37, illustrating the GUI of the front end of a mobile application.

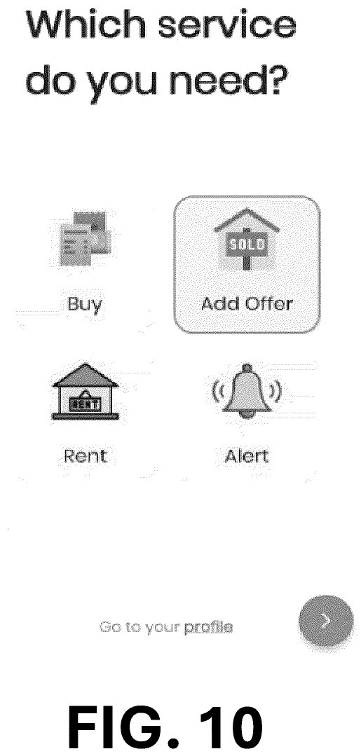

As can be appreciated from FIG. 9, once a user login into the application, a startup screen is shown where the user (which in this example can be a buyer or a seller) is shown the services available which can vary depending on the user selection (i.e., buy a property, rent a property, or add an offer for sale a property). The user presses the “Get Started” button and proceeds to the next screen where the user has the ability to select buttons associated to the type of service desired (i.e., buy a property, rent a property, or add an offer for sale a property), as shown in FIG. 10. In this example, a “Buy” button is provided for a user interested in purchasing a property; a “Rent” button is provided for a user interested in renting a property; and a “Add Offer” button is provided for a user interested in adding a property for sale. In addition, according to this embodiment, an “Alert” button is included in this screen so that the user can create property alerts that will trigger notifications based on specific criteria selected by the user such as but not limited to: a new property being available to buy, receiving a message or an offer from a potential buyer, or even a selling price change of a property of interest. It should be understood that the “Alert” button can also be provided on a different screen.

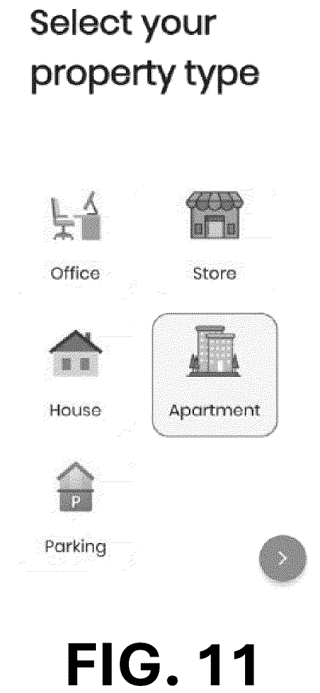

FIGS. 11-22 illustrates the scenario where a seller adds a property into the platform.

As can be appreciated from FIG. 11, the screen shows interactive buttons corresponding to all the types of property that can be sold under the platform which in this non-limiting example are: an office, a store, a house, an apartment and a parking lot. It is envisioned that more types of properties can be shown and available to the users.

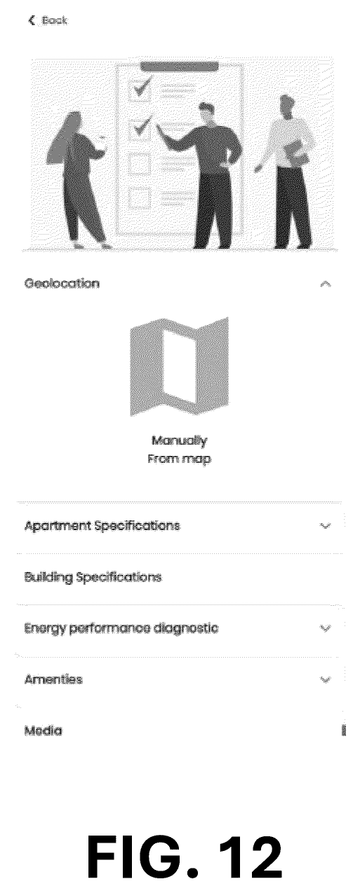

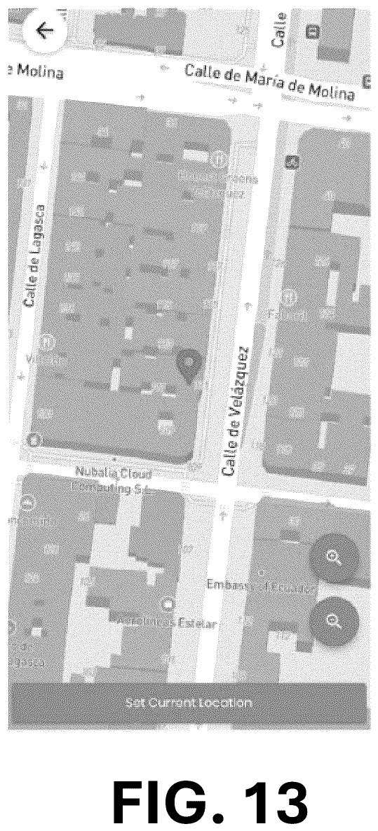

In this example, a user selected the option of selling an apartment so after pressing the “Apartment” button, the screen illustrated in FIG. 12 is shown. In this screen the user will indicated the geographical location of the apartment by manually dropping a pin on a map corresponding to the specific location of the property, as illustrated in FIG. 13. In addition, from this screen the user will provide additional information related to the property such as: the apartment specifications, the building specifications, energy performance, amenities, and any media associated with the property.

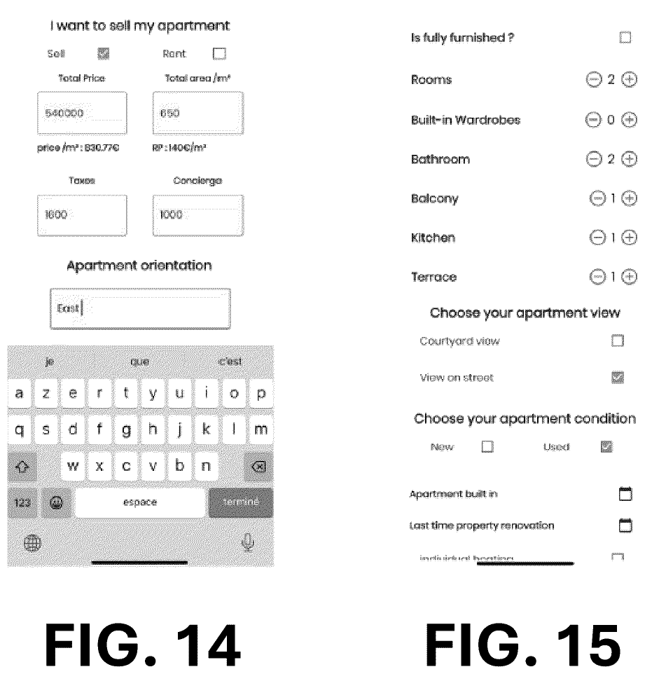

As shown in FIGS. 14-16, when the user selects the “Property Specification” section, a series of screens are provided so that the user can provide at least the following information, as applicable: whether the apartment is for rent or for sell, total area of apartment, total price, related taxes, concierge option price, property orientation (e.g., east), furnishing option, number of rooms, number of built-in wardrobes, number of bathrooms, number of balconies, number of kitchens, number of terraces, the apartment view, the apartment condition, date of construction, date of last renovation, heating, and air conditioning. The user then proceeds to select the “Validate” button so that the application and/or the server processes and evaluates the information provided by the user and indicates if there are any required information missing, a format error or any other issue that would prevent or affect the creation process.

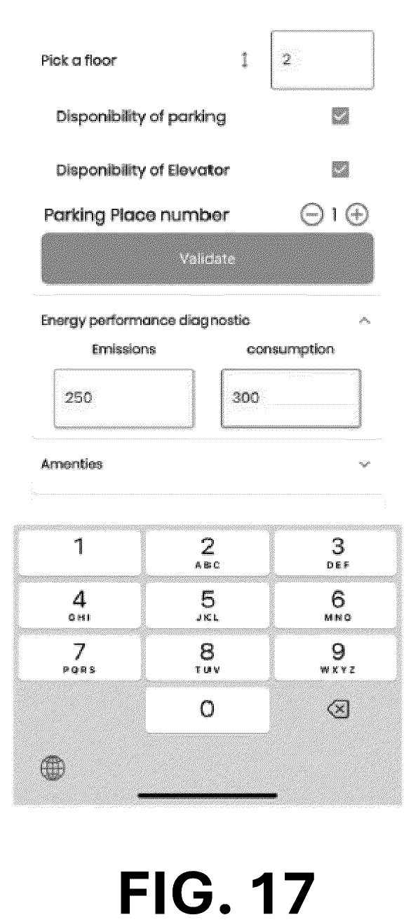

Then, the user selects the “Building Specifications” section and a screen is provided (FIG. 17) so that user enters information related to the building where the apartment is located including without limitation: the floor where the property is located, availability of elevator and parking, as well as the number of parking spots. As with the previous section, the user then proceeds to select the “Validate” button so that the application and/or the server processes and evaluates the information provided by the user and indicates if there are any required information missing, a format error or any other issue that would prevent or affect the creation process. The user also may enter any information related to the energy performance diagnostic of the property, which in this example can in terms of emissions and consumption.

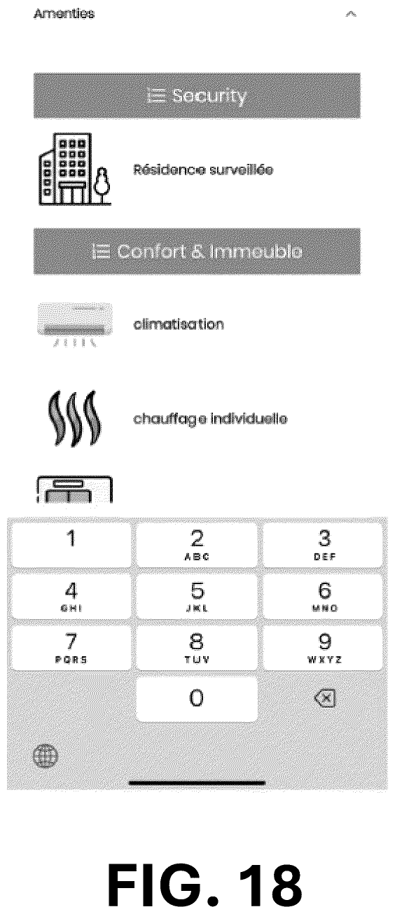

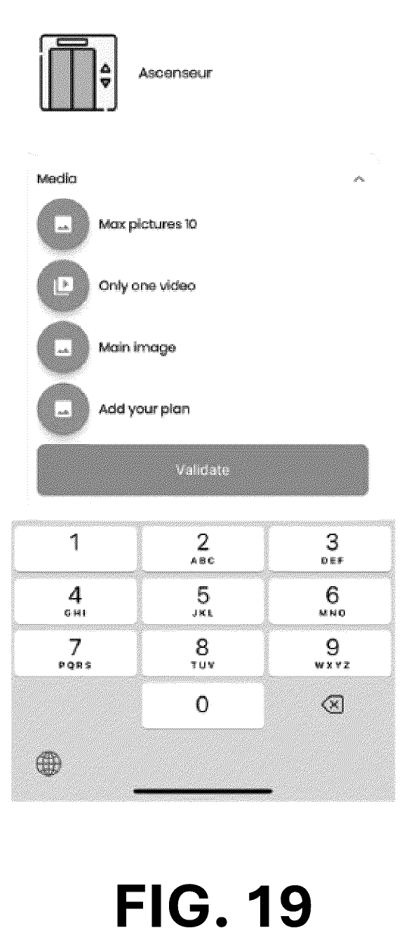

As illustrated in FIGS. 18 and 19, the user can also indicate all the amenities featured by the apartment and/or the building including without limitation: security, surveillance, heating, air conditioning, and/or elevator. Finally, the user may upload audio visual media conveying features or aspects of the apartment and/or the building. For example, media can include without limitations still images, videos, audio, and a plan of the apartment. Again, the user then proceeds to select the “Validate” button so that the application and/or the server processes and evaluates the information provided by the user and indicates if there are any required information missing, a format error or any other issue that would prevent or affect the creation process.

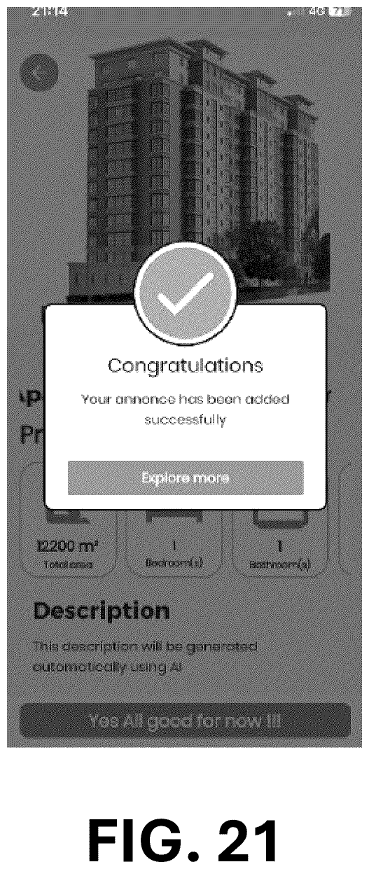

Once the user has provided all the information necessary to create the offer, the application provides a “Preview” feature so that the user can verify the content of the offer as well as get an idea of the “look and feel” of the advertisement prior to submitting the offer into the platform. It is to be understood that at any time, including during the preview step, a user can switch among the different sections to correct and/or update any information. Finally, after submitting the offer, the server process and validates that the submission is in order and sends back to the client device a confirmation which is notified by the application with a message on the screen indicating that the submission has been successful, as shown in FIG. 21.

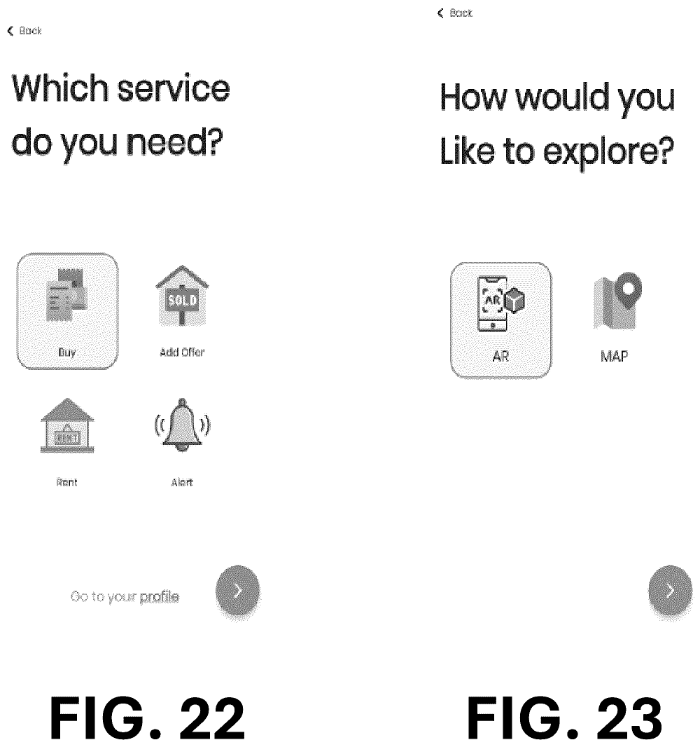

Continuing with the exemplary embodiment, a user may also use the multifaceted real estate platform of the invention to explore real estate properties available to buy or rent, as illustrated in FIG. 22. As shown in FIG. 23, once a user selects the desired option (e.g., buy or rent) a screen is shown where the user selects whether to explore the properties using a traditional map exploration mode or the augmented reality (AR) exploration mode according to the present invention.

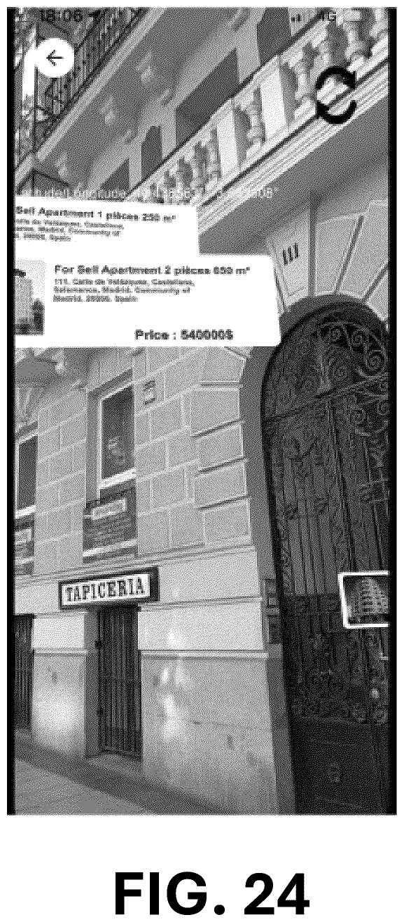

As previously explained, once the AR exploring mode is selected, a user simply needs to point the camera of a client device towards the selected properties, and an icon with a summary of information will appear on the screen if there is a property for sale or rent available in that direction, as shown in FIG. 24. By clicking on this icon, all the provided information can be accessed in detail. In the event that the user opts to alter the current position of the client device and desires to conduct a new search, a “Refresh” button is provided for updating the displayed information by carrying out again the geolocation process previously explained.

One of ordinary skill in the art would understand that the backend and front end operations that provide the above-explained functionalities have been previously explained in relation to FIGS. 1-8 and its associated disclosure.

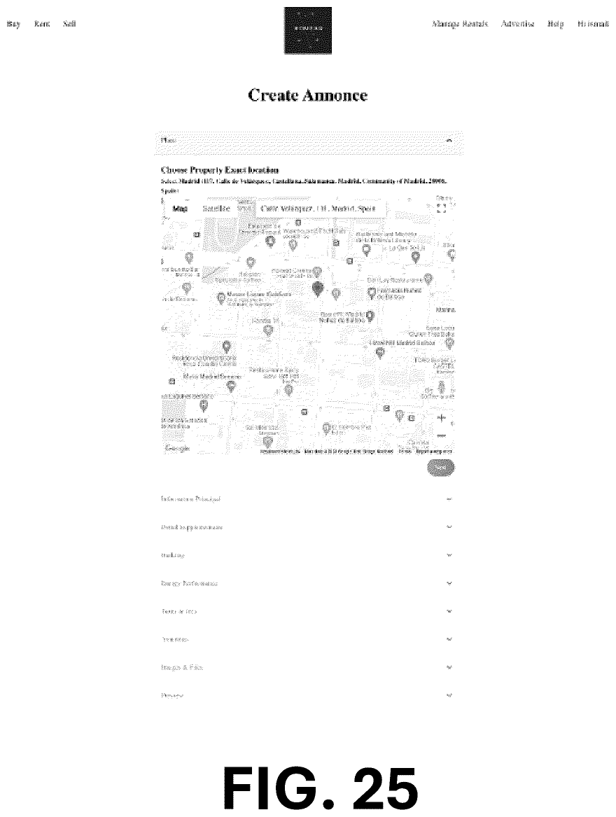

FIGS. 25-35 illustrates another embodiment of the invention for a web-based version of the multifaceted real estate platform. As can be appreciated from the different screenshots, the web-based embodiment is similar to the mobile app embodiment but without the AR functionality and implemented using a web-based platform, as previously explained above.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. A system for listing, exploring, and interacting with real estate properties through augmented reality, the system comprising:
at least one processor; and
at least one memory storing instructions that when executed by the at least one processor, cause the at least one processor to perform operations comprising:
obtaining visual data associated to a field of view of a camera of a client device;
determining a location of the client device based at least on said visual data and geographical location data of said client device;
sending to a server the location of the client device;
receiving from the server at least one real estate property offer having a location within a defined distance of the client device location; and
displaying on said client device, augmented reality (AR) content representing said at least one real estate property offer, wherein said AR content is overlayed over the field of view shown on the display.

2. The system according to claim 1, wherein said at least one processor further performs the operation of anchoring said AR content to geographical coordinates corresponding to real-world locations.

3. The system according to claim 1, wherein said visual data comprises a real-time video stream of the field of view.

4. The system according to claim 1, wherein said at least one processor further performs the operation of requesting from said server property information associated to said at least one real estate property offer when a user interacts with said AR content.

5. The system according to claim 4, wherein said at least one processor further performs the operation of displaying on the client device said property information.

6. The system according to claim 1, wherein said at least one processor further performs the operation of displaying said augmented reality (AR) content on said client device only when the location of the client device is within a predefined distance of the location of said at least one real estate property offer.

7. The system according to claim 1, wherein the geographical location data of said client device comprises latitude, longitude, altitude, orientation, and movement of the client device.

8. The system according to claim 1, wherein said visual data is matched to images of a predefined model corresponding to the real word to assist in determining the location and orientation of the client device.

9. The system according to claim 1, wherein said at least one processor further performs the operation of processing input from sensors of the client device to maintain and update the client device position and orientation.

10. At least one computer-readable storage medium storing instructions for listing, exploring, and interacting with real estate properties through augmented reality, that when executed instruct at least one processor to perform acts comprising:
obtaining visual data of a field of view of a camera of a client device;
determining a location of the client device based at least on said visual data and geographical location data of said client device;
sending to a server the location of the client device;
receiving from the server at least one real estate property offer having a location within a defined distance of the client device location; and
displaying on said client device, augmented reality (AR) content representing said at least one real estate property offer, wherein said AR content is overlayed over the field of view shown on the display.

11. The at least one computer-readable storage medium according to claim 10, wherein said at least one processor further performs the act of anchoring said AR content to geographical coordinates corresponding to real-world locations.

12. The at least one computer-readable storage medium according to claim 10, wherein said visual data comprises a real-time video stream of the field of view.

13. The at least one computer-readable storage medium according to claim 10, wherein said at least one processor further performs the act of requesting from said server property information associated to said at least one real estate property offer when a user interacts with said AR content.

14. The at least one computer-readable storage medium according to claim 13, wherein said at least one processor further performs the act of displaying on the client device said property information.

15. The at least one computer-readable storage medium according to claim 10, wherein said at least one processor further performs the act of displaying said augmented reality (AR) content on said client device only when the location of the client device is within a predefined distance of the location of said at least one real estate property offer.

16. The at least one computer-readable storage medium according to claim 10, wherein the geographical location data of said client device comprises latitude, longitude, altitude, orientation, and movement of the client device.

17. The at least one computer-readable storage medium according to claim 10, wherein said visual data is matched to images of a predefined model corresponding to the real word to assist in determining the location and orientation of the client device.

18. The at least one computer-readable storage medium according to claim 10, wherein said at least one processor further performs the act of processing input from sensors of the client device to maintain and update the client device position and orientation.
